(19) United States
(12) Patent Application Publication
(10) Pub. No.: US 2010/0043306 A1
(43) Pub. Date: Feb. 25, 2010

(54) Small memo board

(76) Inventor: George J. Wajda, San Diego, CA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/230,167

(22) Filed: Aug. 25, 2008

(51) Int. Cl. G09F 15/00; B65D 71/00

(52) U.S. Cl. 52/36.1; 206/223

(57) ABSTRACT

A small memo board is a board fabricated from cork or similar material for displaying reminders. The board is provided with a pressure-sensitive adhesive on its rear surface so that the board may be attached to almost any surface. A release liner covers the adhesive rear surface until the board is ready for use. The board will be made available as a kit containing a number of small memo boards and including small tacks for fastening reminders on the face of the small memo boards.

### BACKGROUND OF THE INVENTION

1. Field of the Invention

The present invention generally relates to display adjuncts. More specifically, the invention is drawn to small boards having self-adhesive rear surfaces and cork front surfaces, which boards are utilized to post memos or notes in convenient areas.

2. Description of the Related Art

There are many instances that require that a reminder, such as a ticket for the theater, grocery list, memo or the like, be fastened or tacked in areas or places where the intended recipient is certain to see it. Such areas or places include, but are not limited to, a windowpane, the surface of a door, a car dashboard, the surface of a computer monitor, etc. The ubiquitous sticky notes are not sufficient because the notes are flimsy and will not support the reminders that need to be placed thereon. The art would certainly be receptive to a device that is capable of retaining reminders thereon and can easily be attached to almost any surface. Thus, a small memo board solving the aforementioned problems is desired.

There are many devices in the related art that are utilized for posting memos thereon. Pertinent examples of such related art are cited and identified in the accompanying IDS. However, none of the cited and identified related art discloses a small memo board as will subsequently be described and claimed in the instant invention.

### SUMMARY OF THE INVENTION

The small memo board of the instant invention is fabricated from cork or similar material. The board is provided with pressure-sensitive adhesive on its rear surface so that the board may be attached to almost any surface. A release liner covers the pressure-sensitive adhesive rear surface until the board is ready for use. As presently contemplated, the memo board will be made available as a kit containing a number of small memo boards, and which also includes small tacks for fastening reminders on the face of the boards.

Accordingly, the invention presents a display device that can be used to leave reminders or the like in almost any area. The invention is available as a kit that includes a plurality of display devices and an array of tacks for attaching the reminders to the devices. The kit can easily be stored in the home, car or office for convenience. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, perspective view of a small memo board according to the present invention.

FIG. 2 is a perspective view of a small memo board according to the present invention as seen from the rear.

FIG. 3 is a perspective view of a kit containing a plurality of small memo boards according to the present invention.

Similar reference characters denote corresponding features consistently throughout the attached drawings.

### DETAILED DESCRIPTION OF THE PREFERRED EMBODIMENTS

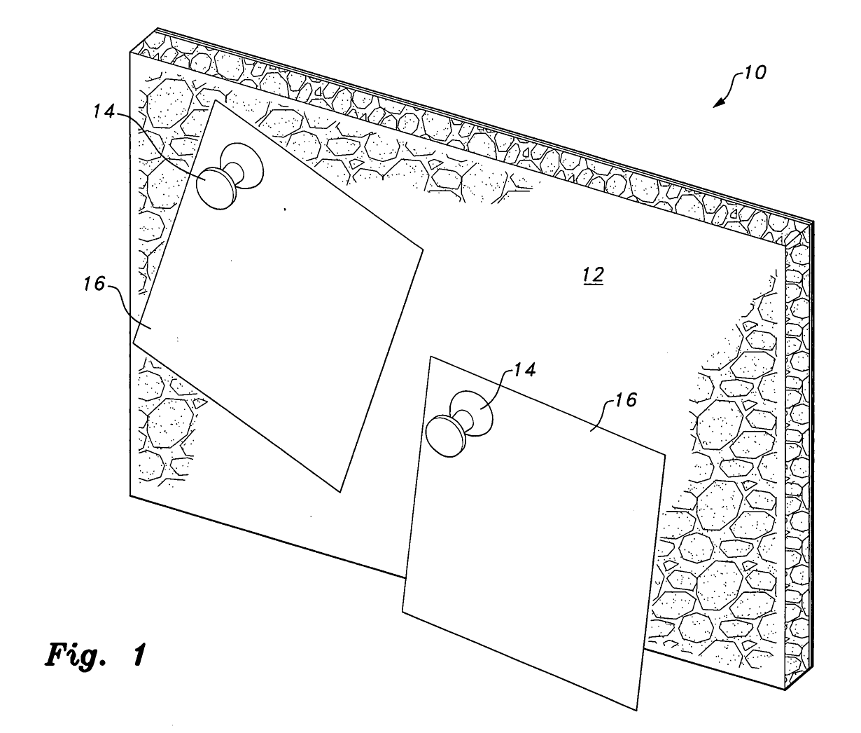

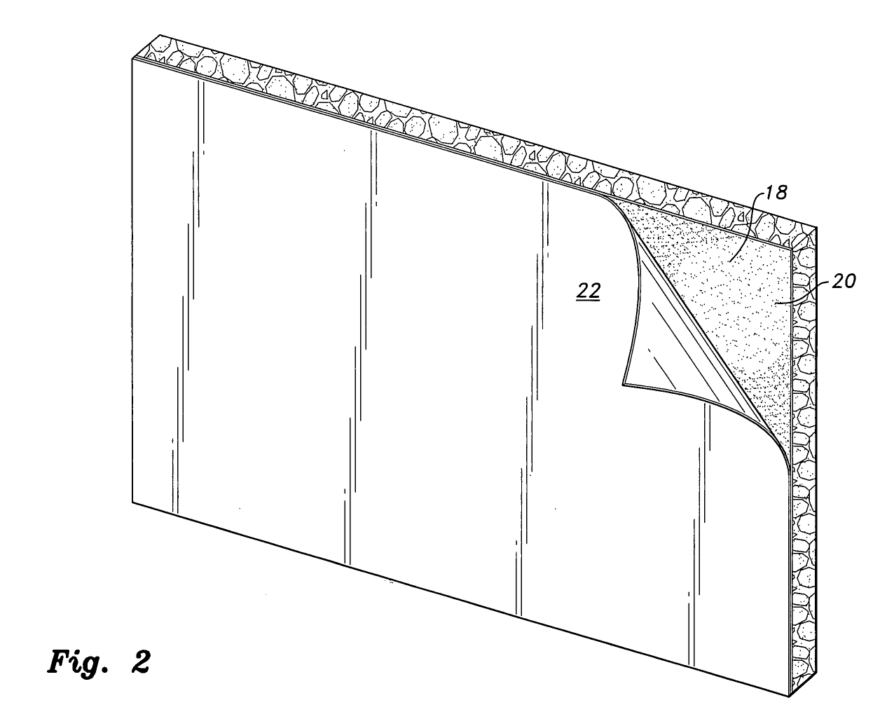

Attention is first directed to FIGS. 1 and 2, wherein the small memo board is generally indicated at 10. Board 10 is fabricated from a soft resilient material, such as cork, that has a front surface 12 capable of retaining small tacks 14 therein. An optimum size for the board 10 will be approximately 3.5 cm high, 1.5 cm wide, and 1.2 cm thick. The exact dimensions of the board 10 may vary, however the board will be of a small size to enhance the ability for positioning on surfaces that can be easily accessed and seen. A variety of small reminder objects 16 can be attached to the board surface 12 by utilizing tacks 14. A conventional pressure-sensitive adhesive 18 is disposed on the rear surface 20 of the board. A release liner 22 is positioned to cover the adhesive 18. Release liner 22 is easily peeled away when it is desired to attach the board 10 to a supporting surface.

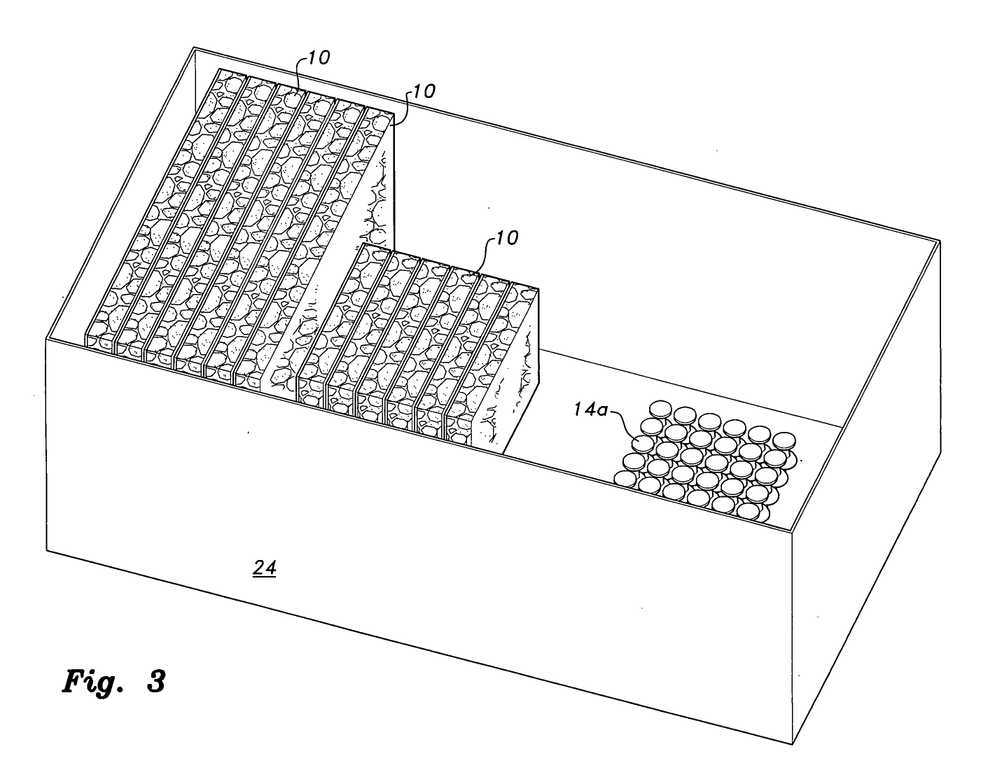

FIG. 3 is illustrative of a kit 24 or container housing a plurality of small memo boards 10 therein. Kit 24 also includes a package of tacks 14a therein. The tacks are multi-colored for aesthetic purposes. The kit 24 allows a user the convenience of having a number of boards 10 and tacks 14a available. The kit 24 may contain boards 10 of different sizes or all boards 10 may be the same size.

It is to be understood that the present invention is not limited to the embodiments described above, but encompasses any and all embodiments within the scope of the following claims.

1-6. (canceled)

7. A kit containing a plurality of display devices, each of the display devices comprising:
a plurality of small boards, each board being fabricated from a cork material and having a front surface and a rear surface, wherein each board is approximately 3.5 cm high, 1.5 cm wide, and 1.2 cm thick;
a pressure-sensitive adhesive disposed on each rear surface;
a release liner overlying said pressure-sensitive adhesive; and
a package of tacks for tacking notes to the small board included in said kit.

8. The kit according to claim 7, wherein said package of tacks includes tacks of differing colors.

9-12. (canceled)
